(19) United States
(12) Patent Application Publication
(10) Pub. No.: US 2014/0181937 A1
(43) Pub. Date: Jun. 26, 2014

(54) INPUT DEVICE, INPUT METHOD AND PROGRAM PRODUCT

(71) Applicant: Kabushiki Kaisha Toshiba, Tokyo (JP)

(72) Inventor: Tomoyuki KOKUBUN, Ome-shi (JP)

(73) Assignee: Kabushiki Kaisha Toshiba, Tokyo (JP)

(21) Appl. No.: 14/013,961

(22) Filed: Aug. 29, 2013

Related U.S. Application Data
(63) Continuation of application No. PCT/JP2013/058410, filed on Mar. 22, 2013.

(30) Foreign Application Priority Data
Dec. 21, 2012 (JP) 2012-280192

(51) Int. Cl. H04L 29/06

(52) U.S. Cl. CPC H04L 63/08
USPC 726/7

(57) ABSTRACT

According to one embodiment, an input device includes: a communication module configured to communicate with a different device connected to the input device; a detector configured to detect biological information of a user; an authentication module configured to check matching between the detected biological information and biological information which is stored in advance; and a controller configured to notify to the different device information indicating a device performing an operation input, and notify to the different device an input code formed as a predetermined input character string when the matching of the biological information is established.

### CROSS-REFERENCE TO RELATED APPLICATIONS

This application is a continuation of International Application No. PCT/JP2013/058410, filed on Mar. 22, 2013 which designates the United States, incorporated herein by reference, and which claims the benefit of priority of Japanese Patent Application No. 2012-280192, filed on Dec. 21, 2012, the entire contents of which are incorporated herein by reference.

### FIELD

Embodiments described herein relate generally to an input device, an input method, and a program product.

### BACKGROUND

Conventionally, an information processing apparatus such as a PC (Personal Computer) is generally configured to receive an input of a predetermined access code such as an ID or a password, which is allocated to each individual, through an input device such as a keyboard or a mouse, and to allow a user, who is verified on the basis of the input access code, to use the apparatus.

However, in the above-mentioned conventional technique, it is necessary to input the predetermined character string such as the access code by operating a keyboard, a mouse, and the like. Accordingly, the technique is inconvenient. Further, when the predetermined character string such as the access code can be easily input through one click or the like, it is possible to perform the input with a simple operation. However, since any one is able to perform the input of the access code, the input is not securely performed.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary conceptual diagram illustrating an example of connection between a PC and an input device according to an embodiment;

FIG. 2 is an exemplary block diagram illustrating a configuration of the PC;

FIG. 3 is an exemplary block diagram illustrating a configuration of the input device according to the embodiment;

FIG. 4 is an exemplary conceptual diagram illustrating an example of a data configuration of registration data;

FIG. 5 is an exemplary flowchart illustrating an example of an operation of the input device according to the embodiment;

FIG. 6 is an exemplary conceptual diagram illustrating an example of an input operation on a login screen;

FIG. 7 is an exemplary conceptual diagram illustrating an example of setting of the input character strings corresponding to the respective fingers of the left hand and the right hand;

FIG. 8 is an exemplary ladder chart illustrating an example of cooperative operations of the PC and the input device; and

FIG. 9 is an exemplary conceptual diagram illustrating an example of connection between a PC and an input device according to a modified example.

### DETAILED DESCRIPTION

In general, according to one embodiment, an input device comprises: a communication module configured to communicate with a different device connected to the input device; a detector configured to detect biological information of a user; an authentication module configured to check matching between the detected biological information and biological information which is stored in advance; and a controller configured to notify to the different device information indicating a device performing an operation input, and notify to the different device an input code formed as a predetermined input character string when the matching of the biological information is established.

Hereinafter, an input device, an input method, and a program according to an embodiment will be described in detail with reference to the accompanying drawings. It should be noted that, although the present embodiment is described in connection with an exemplary case in which a different device connected to the input device is a notebook-type PC and the input device and the notebook-type PC are connected through a USB (Universal Serial Bus), the type of the different device and the method of communication connection are not limited to the embodiment. For example, the different device may be not only the notebook-type PC but also a desktop PC and information devices such as a small-size portable terminal, and may be a television receiver and the like. Further, the communication between the input device and the different device may be not only the connection through a wired system such as the USB but also connections through wireless systems such as a wireless LAN (Local Area Network) and a Bluetooth (registered trademark) system.

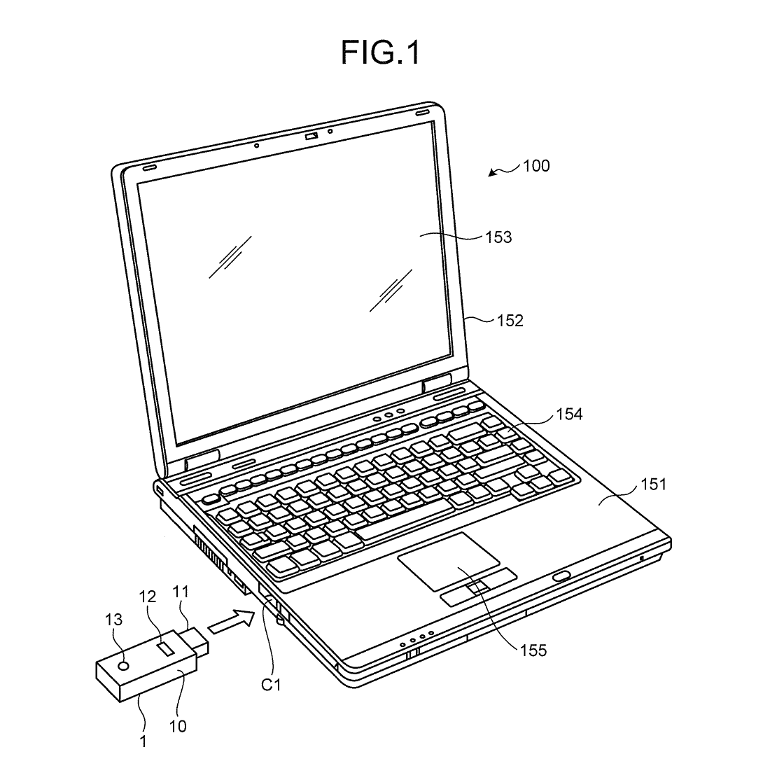

FIG. 1 is a conceptual diagram illustrating an example of connection between a PC 100 and an input device 1 according to the embodiment. As illustrated in FIG. 1, the input device 1 is a device which is used to be inserted into a connector C1 as a USB connector provided on the lateral side of the notebook-type PC 100.

A casing 10 of the input device 1 includes a connection module 11 that is inserted and connected to the connector C1, a fingerprint sensor 12, and an indicating lamp 13. The fingerprint sensor 12 is a line sensor that detects unevenness of a fingerprint by using differences of capacitances when a user touches and slides with his or her finger and two-dimensional scans the unevenness. The indicating lamp 13 is an LED (Light Emitting Diode) or the like, and gives a notification to a user through indications such as lighting or blinking of light with various colors of green, red, and the like.

The PC 100 has not only the connector C1, but also a main body casing 151, a display casing 152, a monitor 153, a keyboard 154, and a touch pad 155.

The main body casing 151 and the touch pad 155 are disposed on the upper surface of the main body casing 151. The display casing 152 holds the peripheral portion of the monitor 153 such that the display area of the monitor 153 is visible. The monitor 153 is a display device such as an LCD (Liquid Crystal Display).

The keyboard 154 is formed of a plurality of keys arranged in a matrix. Here, the keyboard 154 is to input characters or input commands in a way that a user presses the keys, and mainly has character keys for inputting characters and control keys such as “Shift” key, “Ctrl” key, and “Alt” key for implementing special functions by pressing the control keys and the character keys simultaneously. The touch pad 155, which serves as, for example, a pointing device receiving a two-dimensional touch operation of a user in a capacitance type, is disposed on the lower part (front part) of the keyboard 154.

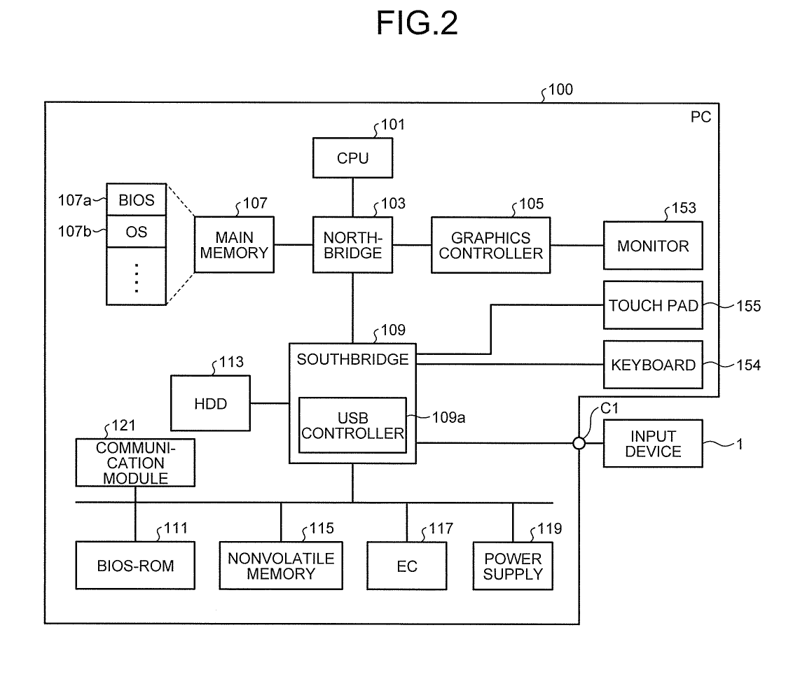

FIG. 2 is a block diagram illustrating a configuration of the PC 100. As illustrated in FIG. 2, the PC 100 includes a CPU (Central Processing Unit) 101, a northbridge 103, a graphics controller 105, a main memory 107, a southbridge 109, a BIOS-ROM (Basic Input/Output System-Read Only Memory) 111, a HDD (hard disk drive) 113, a nonvolatile memory 115, an EC (embedded controller) 117, a power supply 119, and a communication module 121. Further, the connector C1, which is for communicating with the input device 1 complying with the USB standard, is connected to the southbridge 109.

The CPU 101 controls operations of the PC 100, and thereby executes a BIOS 107a and an OS 107b (OS: Operating System) which are loaded on the main memory 107 from the BIOS-ROM 111 and the HDD 113. It should be noted that the BIOS 107a described herein is to reset and diagnose hardware such as a USB device (for example, the input device 1) which is connected through the monitor 153, the touch pad 155, the keyboard 154, and a USB controller 109a. Further, the OS 107b described herein is basic software such as Windows (registered trademark), and is to provide basic functions such as memory management and keyboard input which are commonly used for various kinds of application software.

The northbridge 103 is connected to the CPU 101, the graphics controller 105, the main memory 107, and the southbridge 109. The northbridge 103 includes: an AGP controller that provides an AGP (Accelerated Graphics Port) interface for the graphics controller 105; a host-PCI bridge that connects a local bus, which connects the CPU 101 and the northbridge 103, and a PCI (Peripheral Component Interconnect) bus which connects the northbridge 103 and the southbridge 109; a DRAM (Dynamic Random Access Memory) controller that controls exchange between the main memory 107 and the CPU 101; and the like.

The graphics controller 105 is connected to the monitor 153 such as an LCD through a display connector (not illustrated in the drawing) or the like. The graphics controller 105 includes a RAMDAC (Random Access Memory Digital to Analog Converter), a VRAM (Video Random Access Memory), a video chip, and the like. The graphics controller 105 generates video data on the basis of a drawing instruction received from the CPU 101, records the generated video data into the VRAM, and outputs a completed video to the monitor 153.

The main memory 107 is connected to the northbridge 103, and the BIOS 107a, the OS 107b, and the like are loaded thereon.

The southbridge 109 is connected to the input device 1 through the BIOS-ROM 111, the HDD 113, the nonvolatile memory 115, the EC 117, the power supply 119, the keyboard 154, and the connector C1. In addition, the southbridge 109 includes: an IDE (Integrated Drive Electronics) controller that connects and controls the HDD 113 and the like; a PCI-ISA bridge that is for connecting the PCI bus and the ISA (Industrial Standard Architecture) bus; a multi-I/O controller that controls the input and output of the keyboard 154 which is connected to the PC 100 through a PS (Personal System)/2 keyboard connectors (not illustrated in the drawing), and the like; the USB controller 109a that controls the input device 1 which is connected to the PC 100 through the connector C1 such as a USB connector formed of a standard A plug and a standard A receptacle; and the like.

The USB controller 109a is, for example, a host controller complying with the USB 2.0 standard, and includes: an OHCI (Open Host Controller Interface) host controller core or a UHCI (Universal Host Controller Interface) host controller core; and an EHCI (Enhanced Host Controller Interface) host controller core. The USB controller 109a is able to switch the cores in accordance with the speed of data transfer to the USB device (input device 1).

The USB controller 109a performs control of communication with the USB device in response to a predetermined protocol when the PC is activated or when the connection of the USB device to the connector C1 is detected, acquires the device type, which indicates the type of the device, from the USB device, and loads the driver corresponding to the device type. By loading the driver, it is possible to use the USB device which is connected through the connector C1. For example, when device types indicating the USB keyboard and the USB mouse for an operation input are acquired, the drivers of the USB keyboard and the USB mouse are loaded. By loading the drivers of the USB keyboard and the USB mouse, it is possible to receive inputs of various kinds of key codes and pointing operation information from the USB device which is connected through the connector C1.

The BIOS-ROM 111 is connected to the southbridge 109. The BIOS-ROM 111 stores the BIOS 107a, and the BIOS 107a is loaded on the main memory 107 by the CPU 101 as necessary. Further, the HDD 113 is connected to the southbridge 109. The HDD 113 stores various kinds of application software such as the OS 107b, and the application software is loaded on the main memory 107 by the CPU 101 as necessary. The nonvolatile memory 115 stores various kinds of setting data which is set on a setting screen of the BIOS 107a.

The EC 117 performs power management of the PC 100. The power supply 119 supplies power to the respective modules of the PC 100 under the power management of the EC 117. The communication module 121 performs communication through the wired system (for example, a wired LAN) and the wireless system (for example, a wireless LAN, a Bluetooth system, and the like) under the control of the CPU 101.

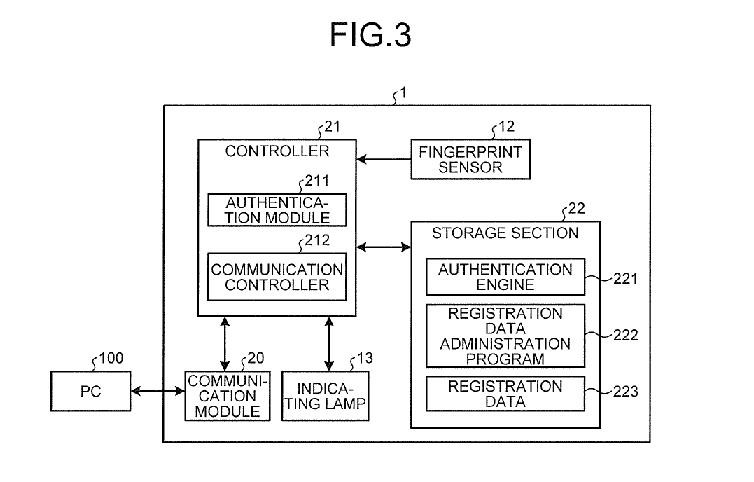

FIG. 3 is a block diagram illustrating a configuration of the input device 1 according to the embodiment. As illustrated in FIG. 3, the input device 1 includes not only the fingerprint sensor 12 and the indicating lamp 13 but also a communication module 20, a controller 21, and a storage 22.

The communication module 20 communicates with the PC 100 under the control of the controller 21. Specifically, the communication complying with the USB standard is performed with the PC 100 which is connected through the connection module 11. Further, the communication module 20 may perform communication through a wireless system such as the wireless LAN system and the Bluetooth system.

The controller 21 is a microprocessor or the like that controls the operation of the input device 1 by executing an application program such as an authentication engine 221 stored in the storage 22. Specifically, the controller 21 controls the fingerprint authentication using the fingerprint sensor 12, the indication of the indicating lamp 13, and the communication of the communication module 20. The controller 21 executes the application program such as the authentication engine 221, thereby implementing functions as the authentication engine 221 and a communication controller 212.

The storage 22 is a rewritable storage device such as a flash memory. The storage 22 stores the authentication engine 221, a registration data administration program 222, and registration data 223.

The authentication engine 221 is an application program that performs the fingerprint authentication of the input device 1, communication control in a case where matching based on the fingerprint authentication is established, and the like. The registration data administration program 222 is a program that executes various kinds of setting (such as registration, delete, and modification) corresponding to the registration data 223. The registration data 223 is data in which biological information and an input character string are registered. The biological information is formed as a matching source of the biometric authentication. The input character string is notified to the PC 100 when matching based on the biological information is established. In addition, the registration data 223 is scrambled on the basis of predetermined key information so as not to be decoded before password authentication for administration in the registration data administration program 222 or internal processing in the controller 21 is acquired.

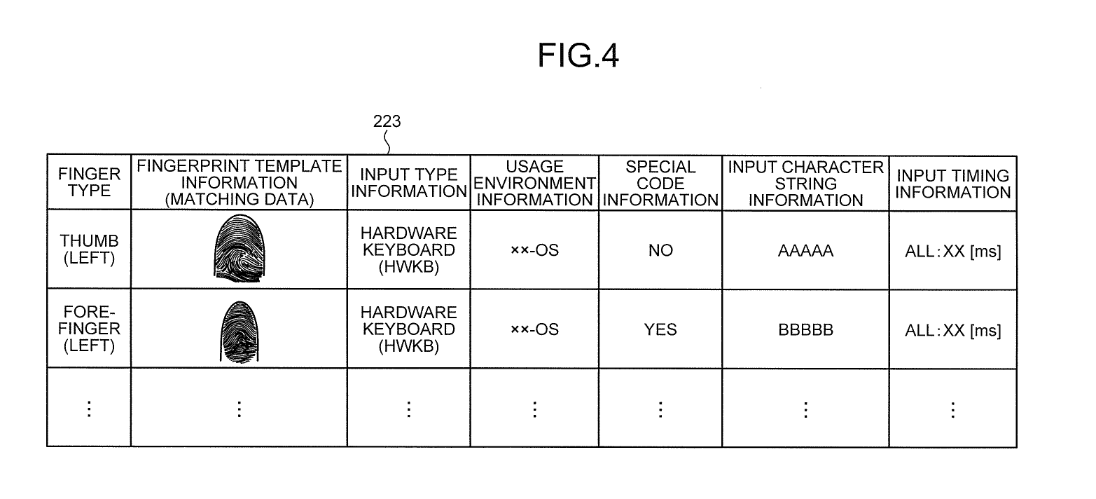

The registration data administration program 222 is executed by performing access from a web browser, which is installed in a host side (PC 100), through a UPNP™ (Universal Plug and Play) interface. By executing the web browser, the registration data administration program 222 is executed, and the password for administration is registered. Thereafter, the PC 100 performs various kinds of setting of fingerprint template information, input type information, usage environment information, special code information, input character string information, input timing information, and the like (refer to FIG. 4) in the registration data 223.

FIG. 4 is a conceptual diagram illustrating an example of a data configuration of the registration data 223. As illustrated in FIG. 4, in the registration data 223, the fingerprint template information, the input type information, the usage environment information, the special code information, the input character string information, and the input timing information are set for each body part of a user (for each finger type of the left hand and the right hand in the present embodiment). It should be noted that, regarding the finger types, there are ten types of the thumb (left), the forefinger (left), . . . the little finger (left), the thumb (right), the forefinger (right), . . . the little finger (right), but in the following description, the types are referred to as the first to fifth fingers of the left hand and the first to fifth fingers of the right hand.

The fingerprint template information is matching data which is formed as the matching source through the biometric authentication. For example, in the fingerprint template information, sensor data is set as matching data of the first finger of the left hand. The sensor data is acquired in a way that a user touches the fingerprint sensor 12 with the thumb (first finger) of the left hand and slides the thumb at the time of the registration by the registration data administration program 222.

The input type information is information which indicates the input types of the hardware keyboard (HWKB) and the software keyboard (SWKB). The usage environment information is information which indicates which OS is appropriate for usage, where an OS name such as “XX-OS” is set.

The special code information is information which indicates whether or not the special code is included when the input code corresponding to the input character string information is notified. Here, the special code is a redundant input code which is formed as an input character string as a whole of the input codes corresponding to the notification. The special code may be, for example, a special key (cursor key, combination between appropriate characters and BS) which is randomly inserted into the input character string. More specifically, assuming that “AAAAA” is the input character string, the special code may be a redundant input code like “BB”+BS+BS which is inserted between “AAA” and “AA”. When such a redundant input code is inserted, it is possible to make keyloggers have difficulty in conjecturing “AAAAA”.

The input character string information is information which indicates the input character string notified to the PC 100 when the matching between the data detected by the fingerprint sensor 12 and the fingerprint template information is established. For example, when the matching based on the registration data 223 is performed in a way that a user touches the fingerprint sensor 12 with the first finger of the left hand, the input code of “AAAAA” as the input character string registered by the first finger is notified to the PC 100.

The input timing information is information that indicates timing of notifying the input code of the input character string, which is indicated by the input character string information, to the PC 100. Regarding the timing, timing of notifying the input character next may be set for each input character. For example, when the input code of “AAAAA” is notified to the PC 100 in a way that a user touches the fingerprint sensor 12 with the first finger of the left hand, every character from the first “A” to the final “A” is notified with an interval of XX [ms].

Returning to FIG. 3, an authentication module 211 performs biometric authentication that checks matching between the fingerprint template information, which is set in the registration data 223, and data which is detected by two-dimensional scanning when a user touches the fingerprint sensor 12 with a finger and slides the finger.

The communication controller 212 notifies information, which indicates devices for an operation input, that is, device types, which indicate the USB keyboard and the USB mouse, to the PC 100 through the communication module 20. Further, when matching between the fingerprint template information and the data detected by the fingerprint sensor 12 in the biometric authentication using the authentication module 211 is established, the communication controller 212 notifies the input code of the input character string, which is set in the registration data 223, to the PC 100 through the communication module 20, in response to the fingerprint template information.

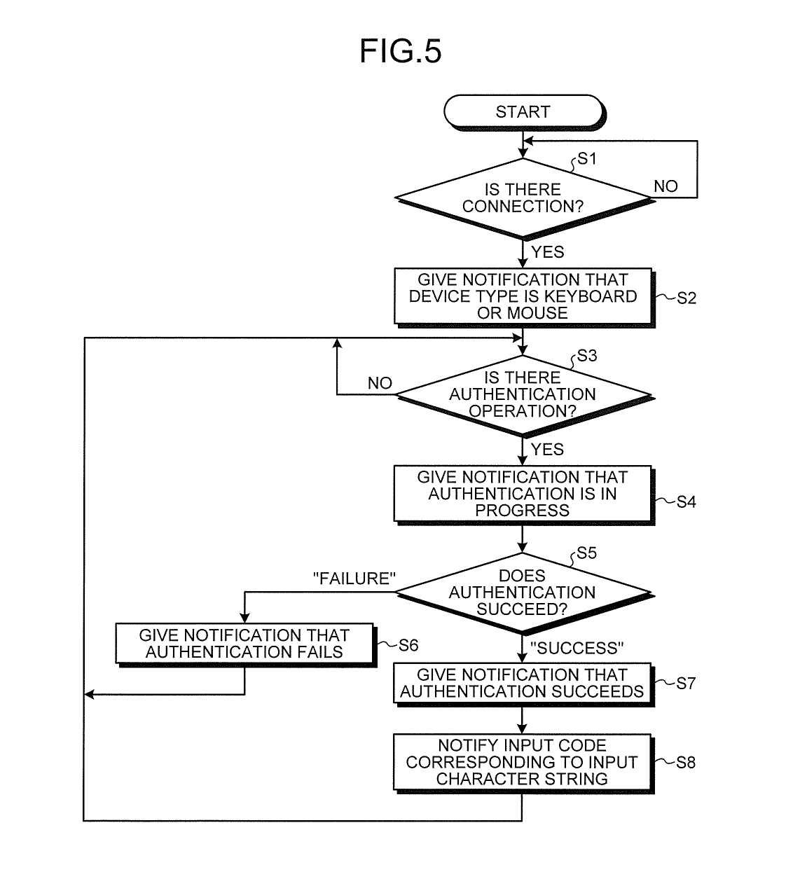

Here, the operation of the input device 1, which is performed under the control of the controller 21, will be described in detail. FIG. 5 is a flowchart illustrating an example of the operation of the input device 1 according to the embodiment.

As illustrated in FIG. 5, when processing is started, the communication controller 212 determines whether or not there is connection to the PC 100 through the communication module 20 (S1). If there is no connection to the PC 100 (NO in S1), the processing is on standby. If the connection is started by connection to the connector C1 of the PC 100 (YES in S1), the communication controller 212 gives the PC 100 a notification that the device type of the input device 1 is “keyboard” (mouse) (S2). Thereby, the PC 100 is able to receive the input codes such as various kinds of the key codes and the pointing operation information based on the input device 1. It should be noted that the controller 21 may notify standby of the authentication, which is performed by a finger, to a user through indication (for example, green lighting) such as lighting or blinking of the indicating lamp 13 during the period from S2 to YES in S3.

Subsequently, the authentication module 211 determines whether or not the authentication operation is present, on the basis of the data detected by the fingerprint sensor 12 (S3). Specifically, the authentication module 211 determines that the authentication operation is present at the time point when the user touches the fingerprint sensor 12 with a finger. If the authentication operation is absent (No in S3), the processing is on standby.

If the authentication operation is present (YES in S3), the controller 21 gives the user a notification that the authentication is in progress, through indication (for example, yellow blinking) such as lighting or blinking of the indicating lamp 13 (S4). Thereby, the user is able to recognize that the authentication of the finger is being performed by touching the fingerprint sensor 12.

Thereafter, the authentication module 211 performs the biometric authentication that checks matching between the data, which is detected by the fingerprint sensor 12, and the fingerprint template information which is set in the registration data 223, thereby determining whether or not the authentication succeeds (S5). Here, when the data detected by the fingerprint sensor 12 is matched with any one fingerprint template information piece which is set in the registration data 223, it is determined that the authentication succeeds. Further, when the data detected by the fingerprint sensor 12 is matched with none of all the fingerprint template information pieces which are set in the registration data 223, it is determined that the authentication fails.

If the authentication fails, the controller 21 gives the user a notification that the authentication fails, through indication (for example, red lighting) such as lighting or blinking of the indicating lamp 13 (S6), and returns the processing to S3. Thereby, the user is able to recognize the failure of the authentication of the finger performed by touching the fingerprint sensor 12.

If the authentication succeeds, the controller 21 gives the user a notification that the authentication succeeds, through indication (for example, green blinking) such as lighting or blinking of the indicating lamp 13 (S7). Thereby, the user is able to recognize the success of the authentication of the finger performed by touching the fingerprint sensor 12.

Then, the communication controller 212 reads the input character string which is set in the registration data 223 in response to the fingerprint template information which is matched through the biometric authentication, notifies the input code corresponding to the input character string to the PC 100 through the communication module 20 (S8), and returns the processing to S3.

The notification of the input code is performed as a key code or pointing device information based on the input type of the hardware keyboard (HWKB) or the software keyboard (SWKB) which is set in the input type information. Specifically, in the case of the hardware keyboard (HWKB), a key code is notified to the PC 100, as if it is input by actually operating the keyboard. Thereby, when the authentication performed by the finger of the user succeeds, the input character string corresponding to the finger is notified to the PC 100, as if it is input by actually operating the keyboard.

Further, in the case of the software keyboard (SWKB), the pointing device information is notified to the PC 100, as if it is input by initiating the software (screen) KB and operating the screen keyboard with a pointing device. Thereby, when the authentication performed by the finger of the user succeeds, the input character string corresponding to the finger is notified to the PC 100, as if it is input by actually operating the screen keyboard. Furthermore, since it is regarded as an operation input of the screen keyboard on the PC 100 side, it is possible to make keyloggers have difficulty in conjecturing.

Further, the notification of the input code is performed by notifying the key code or the pointing device information to the PC 100, as if the input characters are input at the timing which is set in the input timing information. Hence, even in a case of performing processing standby while the PC 100 receives the input characters, this can be dealt by appropriately adjusting the timing.

Furthermore, in the notification of the input code, the above-mentioned special code may be contained in the input code in accordance with whether or not the special code information is present. By making the input code contain the special code, it is possible to make the keyloggers have difficulty in conjecturing the input character string.

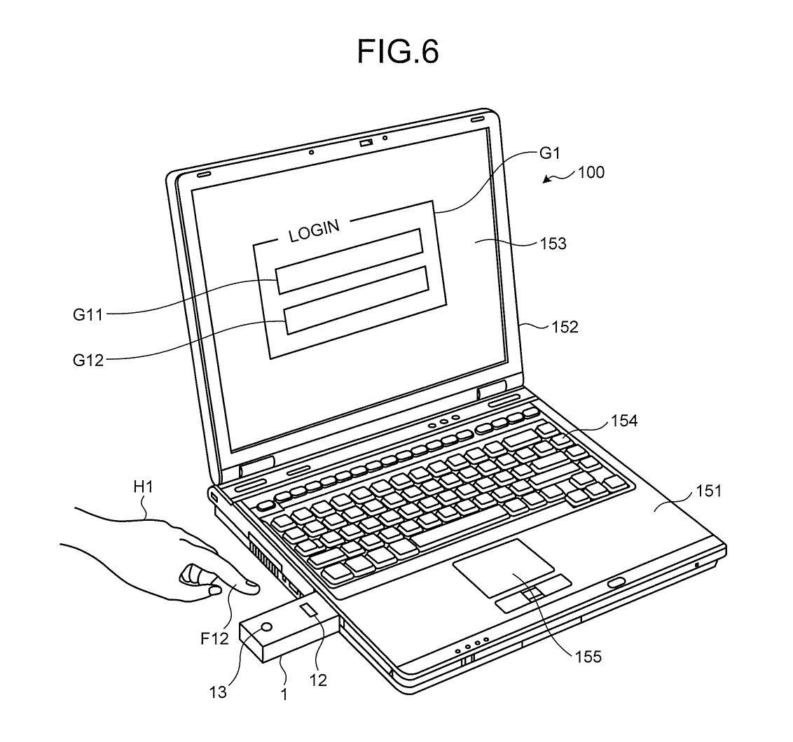

FIG. 6 is a conceptual diagram illustrating an example of an input operation on a login screen G1. As illustrated in FIG. 6, in the login screen G1, it is required to input predetermined character strings, such as user's ID and password which are access codes necessary for the login, into input items G11 and G12. Here, the user's ID or the password is “BBBBB” which is set by a second finger F12 (forefinger) of a left hand H1. In this case, the user performs the authentication of the second finger F12 of the left hand H1 through the fingerprint sensor 12. Thereby, it is possible to perform the input into the input items G11 and G12 without performing the input operation using the keyboard 154, and it is possible to easily and securely input the ID or the password.

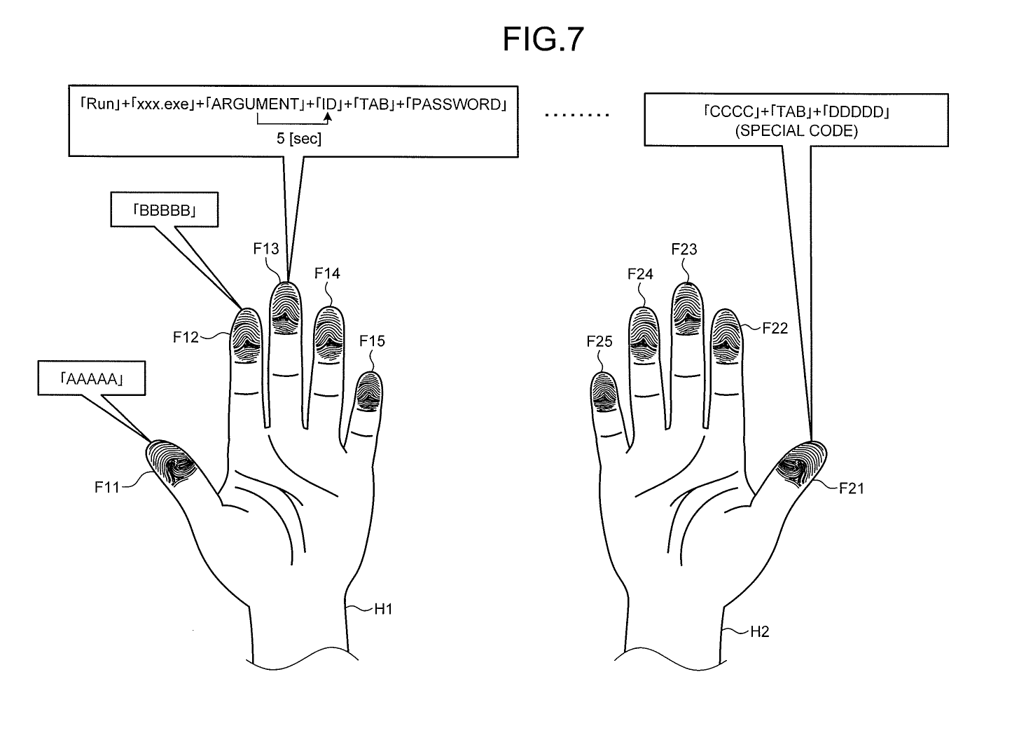

FIG. 7 is a conceptual diagram illustrating an example of setting of the input character strings corresponding to the respective fingers of the left hand H1 and the right hand H2. As illustrated in FIG. 7, setting in the registration data 223 may be made such that respective different input character strings of the first to fifth fingers F11 to F15 of the left hand H1 and the first to fifth fingers F21 to F25 of the right hand H2 can be input. For example, when the ID and the password which are input to the input items G11 and G12 in FIG. 6 are “AAAAA” and “BBBBB”, by performing the authentication of the first finger F11 and the second finger F12, it is possible to perform the input into the input items G11 and G12.

Further, like the input character string of the third finger F13, the input character string may include not only the text inputs into the input items G11 and G12 such as the “ID” and the “password”, but also a keyboard shortcut, an execution command, an argument, a cursor operation such as “TAB”, and the like. Further, a notification may be given such that the input of “ID”+“TAB”+“password” is made at timing at which five [sec] has passed on the basis of the input timing information after the execution command (xxx.exe) is executed as an argument through the keyboard shortcut (Run). In this case, the display of the login screen G1 performed by the execution command is awaited, and then the inputs of the “ID” and the “password” may be performed.

Furthermore, like the input character string of the first finger F21, the input code may include a special code (for example, “BB”+BS+BS or the like) at the time of inputting “CCCC”+“TAB”+“DDDDD”.

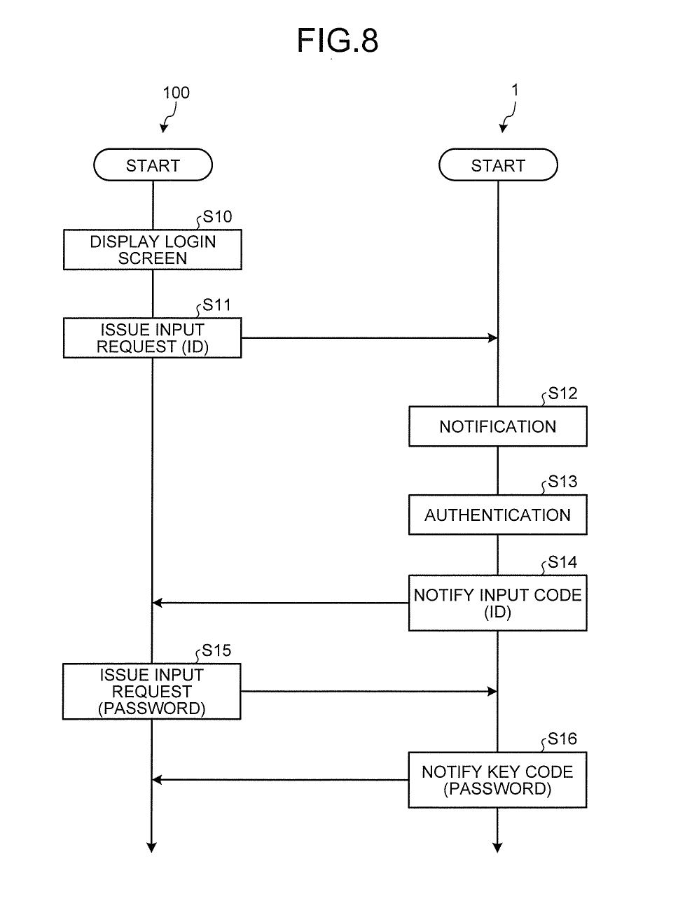

In addition, the notification of the input code to the PC 100, which is given when the authentication succeeds, may be performed by cooperative operations of the PC 100 and the input device 1 in such a case where there is a request from the PC 100. FIG. 8 is a ladder chart illustrating an example of the cooperative operations of the PC 100 and the input device 1.

As illustrated in FIG. 8, when the processing is initiated, the PC 100 displays the login screen G1 (S10), and issues an ID input request to the input device 1 (S11). The input device 1 notifies the authentication for the ID/password input to the user through indication (for example, yellow lighting) such as lighting or blinking of the indicating lamp 13, in response to the ID input request (S12). Thereby, the user is able to recognize that the ID/password input performed by touching the fingerprint sensor 12 is on standby.

Subsequently, the input device 1 authenticates the user corresponding to the ID/password input (S13). In S13, in a case where the ID and the password are respectively set in different two fingers, the authentication is performed on the two fingers. Further, like the first finger F21 of FIG. 7, in a case where the ID of “CCCC” and the password of “DDDDD” are set in a single finger, the authentication is performed on only the first finger F21. Then, the communication controller 212 of the input device 1 notifies the input code corresponding to the ID to the PC 100, in response to the ID input request (S14).

After the notification of the input code corresponding to the ID, the PC 100 issues the password input request to the input device 1 (S15). When receiving the password input request, the communication controller 212 notifies the input code corresponding to the password to the PC 100 on the basis of the result of the authentication in S13 (S16). As described above, the communication controller 212 of the input device 1 may notify the input code in response to the request issued from the PC 100.

### MODIFIED EXAMPLE

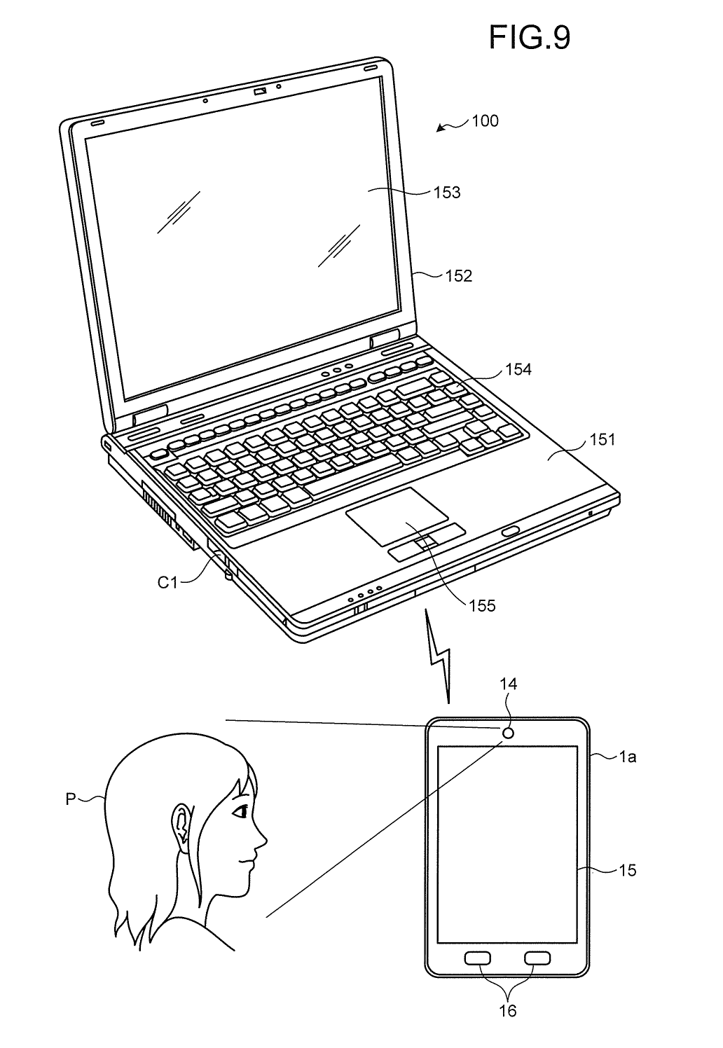

Next, as a modified example of the above-mentioned embodiment, an exemplary case where the input device is a portable terminal such as a smart phone will be described. FIG. 9 is a conceptual diagram illustrating an example of connection between an input device 1a and the PC 100 according to a modified example.

As illustrated in FIG. 9, the input device 1a may be a portable terminal that communicates with the PC 100 through a wireless system such as the Bluetooth system. Further, the input device 1a includes: a camera 14 that is capable of capturing an image of a face of a person P; a display operation module 15 in which a touch sensor is mounted on an LCD; and an operation key 16 that is for a key operation. In addition, an application program for implementing functions of the authentication module 211 and the communication controller 212 is installed in the input device 1a in advance. Accordingly, at the time of input to the PC 100, the application program is selected and executed.

By selecting and executing the application program, at the time of wireless communication with the PC 100, the input device 1a gives the PC 100 a notification that the device type is a “keyboard” (mouse). Subsequently, the input device 1a captures the face image of the person P with the camera 14 instead of the fingerprint authentication of the user performed by using the fingerprint sensor 12, and performs biometric authentication that checks matching between the captured face image and a face image which is set in advance. Then, when the matching based on the biometric authentication succeeds, the input device 1a notifies a preset input code to the PC 100 through the wireless system. As described above, the biometric authentication may be applied to a fingerprint of each finger of the user, a face of a user, and the like, and is not particularly limited if the body part of the user and the authentication method can be applied to distinguish each individual user.

It should be noted that the programs executed by the input devices 1 and 1a of the present embodiment are provided to be installed in a ROM or the like in advance. The programs executed by the input devices 1 and 1a of the present embodiment may be configured to be provided in a state where each program is recorded as an installable format or executable format file in a computer-readable recording medium such as a CD-ROM, a flexible disk (FD), a CD-R, or a DVD (Digital Versatile Disk).

Further, each program executed by the input devices 1 and 1a of the present embodiment may be stored in a computer which is connected to a network such as the Internet, and may be configured to be provided by downloading it through the network. Furthermore, each program executed by the input devices 1 and 1a of the present embodiment may be configured to be provided or distributed through a network such as the Internet.

Each program executed by the input devices 1 and 1a of the present embodiment is formed of modules having the above-mentioned function configurations. Thus, the CPU (processor) as actual hardware reads and executes the program from the ROM, and thereby loads the respective modules on the main storage device. In such a way, the program is generated on the main storage device.

It should be noted that the present invention is not limited to the present embodiment as it is, and may be embodied by modifying the components without departing from the scope thereof. Further, various modifications of the invention may be made by appropriately combining the plurality of components disclosed in the present embodiment. For example, some of all the components illustrated in the embodiment may be removed. Furthermore, the components according to a different embodiment may be appropriately combined.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An input device comprising:
a communication module configured to communicate with a different device connected to the input device;
a detector configured to detect biological information of a user;
an authentication module configured to check matching between the detected biological information and biological information which is stored in advance; and
a controller configured to notify to the different device information indicating a device performing an operation input, and notify to the different device an input code formed as a predetermined input character string when the matching of the biological information is established.

2. The input device of claim 1, wherein the information indicating the device performing the operation input, is information indicating a keyboard.

3. The input device of claim 1, further comprising
a storage configured to store the biological information and the predetermined input character string when the matching of the biological information is established, for each part of a body of the user,
wherein when the matching of the biological information of the part subjected to the biometric authentication is established, the controller notifies the input code formed as the predetermined input character string corresponding to the part.

4. The input device of claim 1, further comprising
a timing setting module configured to set timing at which the input code is notified,
wherein the controller is configured to notify the input code at the set timing.

5. The input device of claim 1, further comprising
an input code setting module configured to set whether the input code contains a redundant input code,
wherein the controller notifies the input code corresponding to the predetermined input character string when the input code does not contain the redundant input code, and notifies the input code which contains the redundant input code formed as the predetermined input character string as a whole when the input code contains the redundant input code.

6. The input device of claim 1, wherein the detector is configured to detect a face image or a fingerprint of each finger of the user as biological information.

7. The input device of claim 1, wherein the controller notifies the predetermined input character string in response to a request from the different device when the matching of the biological information is established.

8. The input device of claim 1, further comprising a display configured to display at least one of a state where the matching of the biological information is established, a state where the matching of the biological information is not established, and a state where the biometric authentication is in progress.

9. The input device of claim 1, wherein the input code is either one of a key code corresponding to an operation of a hardware keyboard for the predetermined input character string, or pointing operation information corresponding to an operation of a software keyboard for the predetermined input character string.

10. An input method comprising
communicating with a different device connected to the input device;
detecting biological information of a user;
checking matching between the detected biological information and biological information which is stored in advance; and
notifying to the different device information indicating a device performing an operation input, and notifying to the different device an input code formed as a predetermined input character string when the matching of the biological information is established.

11. A computer program product having a non-transitory computer readable medium including programmed instructions, wherein the instructions, when executed by a computer, cause the computer to perform:
communicating with a different device connected to the input device;
detecting biological information of a user;
checking matching between the detected biological information and biological information which is stored in advance; and
notifying to the different device information indicating a device performing an operation input, and notifying to the different device an input code formed as a predetermined input character string when the matching of the biological information is established.
